(19) United States
(12) Patent Application Publication
(10) Pub. No.: US 2025/0103210 A1
(43) Pub. Date: Mar. 27, 2025

(54) MEMORY SYSTEM AND OPERATION METHOD THEREOF

(71) Applicant: YANGTZE MEMORY TECHNOLOGIES CO., LTD., Wuhan (CN)

(72) Inventor: Weiyi ZHAO, Wuhan (CN)

(21) Appl. No.: 18/405,063

(22) Filed: Jan. 5, 2024

(30) Foreign Application Priority Data
Sep. 21, 2023 (CN) 2023112325855

(51) Int. Cl. G06F 3/06

(52) U.S. Cl. CPC G06F 3/0613; G06F 3/0659; G06F 3/0679

(57) ABSTRACT

Examples provide a memory system including a memory device having a plurality of memory pages and a memory controller. The memory controller is coupled with the memory device and configured to: send a first command that indicates to perform a read operation on the data in a target memory page at a first read voltage; obtain a first value and a second value read from the target memory page, the read data being the first value when the threshold voltage of a memory cell is lower than the first read voltage, and the read data being the second value when the threshold voltage of the memory cell is larger than the first read voltage; obtain the difference between a number of the first value and a number of the second value; and determine whether the first read voltage is the target read voltage according to the difference.

### CROSS-REFERENCE TO RELATED APPLICATIONS

The present application claims priority to Chinese Patent Application No. 2023112325855, which was filed Sep. 21, 2023, is titled “MEMORY SYSTEM AND ITS OPERATING METHOD,” and is hereby incorporated herein by reference in its entirety.

### TECHNICAL FIELD

The present disclosure relates to, but is not limited to, a memory system and an operation method thereof.

### BACKGROUND

With the rapid development of data storage technology, more and more data memory systems can be found in electronic devices used in the society, such as solid state drives (SSDs) and the like. SSDs have been widely used in military, vehicle, industry, medical, aviation and other fields due to their characteristics such as fast speed, shock resistance, low power consumption, no noises, low heat generation and small weight.

However, there still remain many problems to be solved about the memory systems in the related art.

### SUMMARY

According to the first aspect of examples of the present disclosure, a memory system is provided, which includes a memory device and a memory controller coupled with the memory device, wherein the memory device includes a plurality of memory pages, and the memory controller is configured to: send a first command that indicates to perform a read operation on the data in a target memory page at a first read voltage; obtain a first value and a second value read from the target memory page, the read data being the first value when the threshold voltage of a memory cell is lower than the first read voltage, and the read data being the second value when the threshold voltage of the memory cell is larger than the first read voltage; obtain the difference between a number of the first value and a number of the second value; and determine whether the first read voltage is the target read voltage according to the difference between the number of the first value and the number of the second value.

In the example above, the memory controller is configured to: determine the first read voltage not to be the target read voltage when the absolute value of the difference between the number of the first value and the number of the second value is larger than a preset value; and determine the first read voltage to be the target read voltage when the absolute value of the difference between the number of the first value and the number of the second value is smaller than or equal to the preset value.

In the example above, the preset value is in the range of 100 to 300.

In the example above, each of the memory pages includes a plurality of memory cells, each of which stores one bit of data.

In the example above, the memory controller is configured to: send a second command when the absolute value of the difference between the number of the first value and the number of the second value is larger than a preset value and the number of the first value is larger than the number of the second value, the second command indicating to perform a read operation on the data in the target memory page at a second read voltage, the second read voltage being smaller than the first read voltage; and send a third command when the absolute value of the difference between the number of the first value and the number of the second value is larger than the preset value and the number of the first value is smaller than the number of the second value, the third command indicating to perform a read operation on the data in the target memory page at a third read voltage, the third read voltage being larger than the first read voltage.

In the example above, the memory controller includes a register and is configured to: store the first value and the second value read from the target memory page into the register temporarily; and counting the numbers of the first value and the second value using the register.

In the example above, the memory page corresponds to a read voltage table that includes a plurality of read voltages arranged in order from small to large, the values of two adjacent read voltages differing by a fixed offset; and the memory controller is configured to: select a read voltage from the read voltage table using a dichotomization method to perform a read operation on the data in the target memory page, when the read operation is performed on the target memory page.

In the example above, the memory system includes a memory card or a solid-state drive.

In the example above, the memory device includes a memory array and a peripheral circuit coupled with the memory array, and the peripheral circuit is configured to: receive the first command sent from the memory controller; and send the first value and the second value read from the target memory page to the memory controller.

According to the second aspect of examples of the present disclosure, an operation method of a memory system is provided, which includes: sending a first command that indicates to perform a read operation on the data in a target memory page at a first read voltage; obtaining a first value and a second value read from the target memory page, the read data being the first value when the threshold voltage of a memory cell is lower than the first read voltage, and the read data being the second value when the threshold voltage of the memory cell is larger than the first read voltage; obtaining the difference between a number of the first value and a number of the second value; and determining whether the first read voltage is the target read voltage according to the difference between the number of the first value and the number of the second value.

In the example above, the determining whether the first read voltage is the target read voltage according to the difference between the number of the first value and the number of the second value includes: determining the first read voltage not to be the target read voltage when the absolute value of the difference between the number of the first value and the number of the second value is larger than a preset value; and determining the first read voltage to be the target read voltage when the absolute value of the difference between the number of the first value and the number of the second value is smaller than or equal to the preset value.

In the example above, the preset value is in the range of 100 to 300.

In the example above, the method further includes: sending a second command when the absolute value of the difference between the number of the first value and the number of the second value is larger than a preset value and the number of the first value is larger than the number of the second value, the second command indicating to perform a read operation on the data in the target memory page at a second read voltage, the second read voltage being smaller than the first read voltage; and sending a third command when the absolute value of the difference between the number of the first value and the number of the second value is larger than the preset value and the number of the first value is smaller than the number of the second value, the third command indicating to perform the read operation on the data in the target memory page at a third read voltage, the third read voltage being larger than the first read voltage.

In the example above, the obtaining the first value and the second value read from the target memory page and obtaining the difference between the number of the first value and the number of the second value include: storing the first value and the second value read from the target memory page into a register of the memory controller temporarily; and counting the numbers of the first value and the second value using the register.

In the example above, the memory page corresponds to a read voltage table that includes a plurality of read voltages arranged in order from small to large, the values of two adjacent read voltages differing by a fixed offset; and the method further includes: selecting a read voltage from the read voltage table using a dichotomization method to perform a read operation on the data in the target memory page, when the read operation is performed on the target memory page.

In the example above, the operation method further includes: receiving the first command sent from the memory controller of the memory system; and sending the first value and the second value read from the target memory page to the memory controller.

Examples of the present disclosure provide an operation method of a memory system, which includes: sending a first command that indicates to perform a read operation on the data in a target memory page at a first read voltage; obtaining a first value and a second value read from the target memory page, the read data being the first value when the threshold voltage of a memory cell is lower than the first read voltage, and the read data being the second value when the threshold voltage of the memory cell is larger than the first read voltage; obtaining the difference between the number of the first value and the number of the second value; and determining whether the first read voltage is the target read voltage according to the difference between the number of the first value and the number of the second value. In examples of the present disclosure, by performing the read operation on the target memory page at the first read voltage and then determining whether the first read voltage is the target read voltage according to the difference between the number of the first value and the number of the second value, the position of the target voltage can be determined rapidly, accurately and efficiently, so that the error correction capability of low density parity check codes and the read efficiency can be improved.

### BRIEF DESCRIPTION OF THE DRAWINGS

FIG. 1 is a schematic diagram of an example system having a memory system in an example of the present disclosure.

FIG. 2A is a schematic diagram of an example memory card having a memory system in an example of the present disclosure.

FIG. 2B is a schematic diagram of an example solid state drive having a memory system in an example of the present disclosure.

FIG. 3A is a schematic diagram illustrating distribution of memory cells in a three-dimensional (3D) NAND memory in an example of the present disclosure.

FIG. 3B is a schematic diagram of an example memory device including a peripheral circuit in an example of the present disclosure.

FIG. 4 is a cross-sectional diagram of a memory array including a memory string in an example of the present disclosure.

FIG. 5 is a schematic diagram of an example memory including a memory array and a peripheral circuit in an example of the present disclosure.

FIG. 6 is a schematic diagram of the framework structure of a memory system in an example of the present disclosure.

FIG. 7 is a flowchart of example of an operation method of a memory system in an example of the present disclosure.

FIG. 8 is a schematic diagram of the distribution of the threshold voltage of a memory cell in an example of the present disclosure.

FIG. 9 is a block diagram of an operation method of a memory system provided in the example of the present disclosure.

### DETAILED DESCRIPTION

Hereinafter, examples disclosed by the present disclosure will be described in more detail with reference to accompanying drawings. Although examples of the present disclosure are illustrated in accompanying drawings, it should be understood that the present disclosure can be embodied in various forms and is not limited to the examples described herein. On the contrary, the examples are provided for more thorough understanding of the present disclosure and to convey the scope disclosed by the present disclosure to those skilled in the art.

In the description hereafter, many details are provided to facilitate more thorough understanding of the present disclosure. However, it is apparent for those skilled in the art that the present disclosure can be implemented without one or more of these details. In other examples, in order not to obscure the present disclosure, some technical features well known in the art will not be described. For example, not all features of practical examples will be described herein and well-known functions and structures will not be described in detail.

In accompanying drawings, the dimensions of layers, regions and elements and their relative dimensions may be exaggerated for clearance. The same reference numeral refers to the same element throughout the specification.

It should be appreciated that when an element or a layer is said to be “over”, “adjacent to”, “connected to” or “coupled to” another element or layer, it may be directly over, adjacent to, connected to or coupled to the another element or layer or an intervening element or layer may exist therebetween. When an element is said to be “directly on”, “directly adjacent to”, “directly connected to” or “directly coupled to” another element or layer, there is no intervening element or layer therebetween. It should be appreciated that although various elements, components, regions, layers and/or parts may be described using terms “first”, “second”, “third” or the like, they are not limited by those terms. The terms are only used to distinguish one element, component, region, layer or part from another element, component, region, layer or part. Therefore, a first element, component, region, layer or part discussed hereafter may be instead expressed as a second element, component, region, layer or part without departing from the teaching of the present disclosure. When a second element, component, region, layer or part is in discussion, it is not intended to indicate that a first element, component, region, layer or part must exist.

Spatially relative terms, such as “below”, “beneath”, “lower”, “under”, “over” and “above”, are used herein for ease of description to describe the relationship of one element or feature with other elements or features as shown in the figures. It should be appreciated that, in addition to the orientations shown in the figures, the spatial relationship terms are intended to include different orientations of devices in use and operation. For example, if a device in the figure is turned upside down, the element or feature described to be “beneath”, “under” or “below” another element or feature will have the orientation of being “over” the another element or feature. Therefore, example terms “beneath” and “under” may include orientations of both “below” and “above”. Devices may be otherwise oriented (rotated 90 degrees or at other orientations) and the spatially relative descriptors used herein may likewise be interpreted accordingly.

Terminology is used herein only for description of examples and in no way for limiting the present disclosure. As used herein, the terms “a”, “an” and “the” in singular forms are also intended to cover plural forms, unless the context clearly indicates otherwise. It should also be appreciated that terms “composing” and/or “including”, as used in the specification, specify presence of the mentioned features, integers, operations, operations, elements and/or components, but do not exclude presence or addition of one or more other features, integers, operations, operations, elements, components and/or combinations thereof. As used herein, the term “and/or” includes any and all combinations of relevant listed items.

In order to understand the characteristics and technical contents of examples of the present disclosure more thoroughly, the examples of the present disclosure will be described in detail hereafter with reference to accompanying drawings, which are only for reference and illustration and not for definition of examples of the present disclosure.

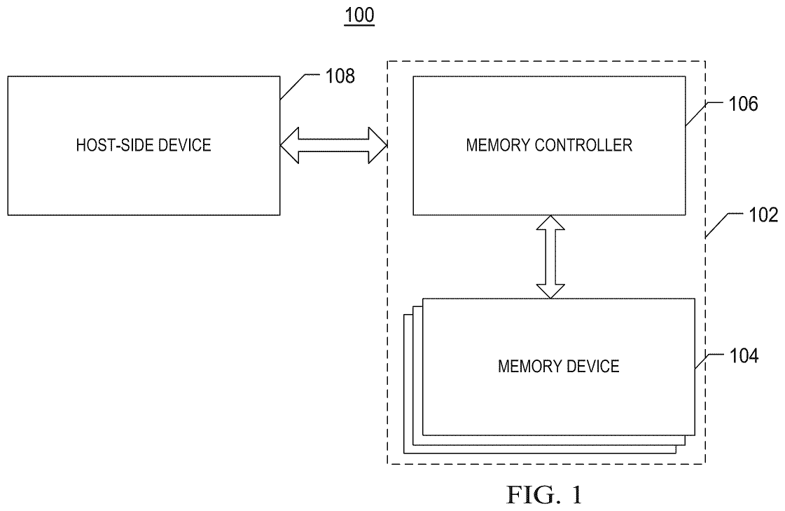

FIG. 1 shows a block diagram of an example system 100 having a memory in accordance with some aspects of the present disclosure. The system 100 can be a mobile phone, a desktop computer, a laptop computer, a tablet computer, a vehicle computer, a gaming console, a printer, a positioning device, a wearable electronic device, a smart sensor, a virtual reality (VR) device, an augmented reality device or any other suitable electronic device having storage therein. As shown in FIG. 1, the system 100 may include a host-side device 108 and a memory system 102 that has one or more memory devices 104 and a memory controller 106. The host-side device 108 may be a processor of an electronic device (e.g., a central processing unit (CPU)) or a system on chip (e.g., an application processor). The host-side device 108 may be configured to send data to the memory device 104 or receive data from the memory device 104.

According to some examples, the memory controller 106 is coupled to the memory device 104 and the host-side device 108 and is configured to control the memory device 104. The memory controller 106 can manage the data stored in the memory device 104 and communicate with the host-side device 108. In some examples, the memory controller 106 is designed for operating in a low duty-cycle environment like secure digital cards, compact flash cards, universal serial bus flash drives, or other media for use in electronic devices such as personal computers, digital cameras, mobile phones, etc. In some examples, the memory controller 106 is designed for operating in a high duty-cycle environment like an SSD or an embedded multi-media-card, used as a data storage for a of mobile device such as a smart phone, a tablet computer or a laptop computer, and an enterprise storage array.

The memory controller 106 can be configured to control operations of the memory device 104, such as read, erase, and program operations. The memory controller 106 can also be configured to manage various functions with respect to the data stored or to be stored in the memory device 104, including but not limited to bad-block management, garbage collection, logical-to-physical address conversion, wear leveling and the like. In some examples, the memory controller 106 is further configured to process error correction codes with respect to the data read from or written to the memory device 104. Any other suitable functions can be performed by the memory controller 106 as well, for example, formatting the memory device 104. The memory controller 106 can communicate with an external device (e.g., the host-side device 108) according to a particular communication protocol. For example, the memory controller 106 may communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface protocol, an integrated drive electronics protocol, a firmware protocol, etc.

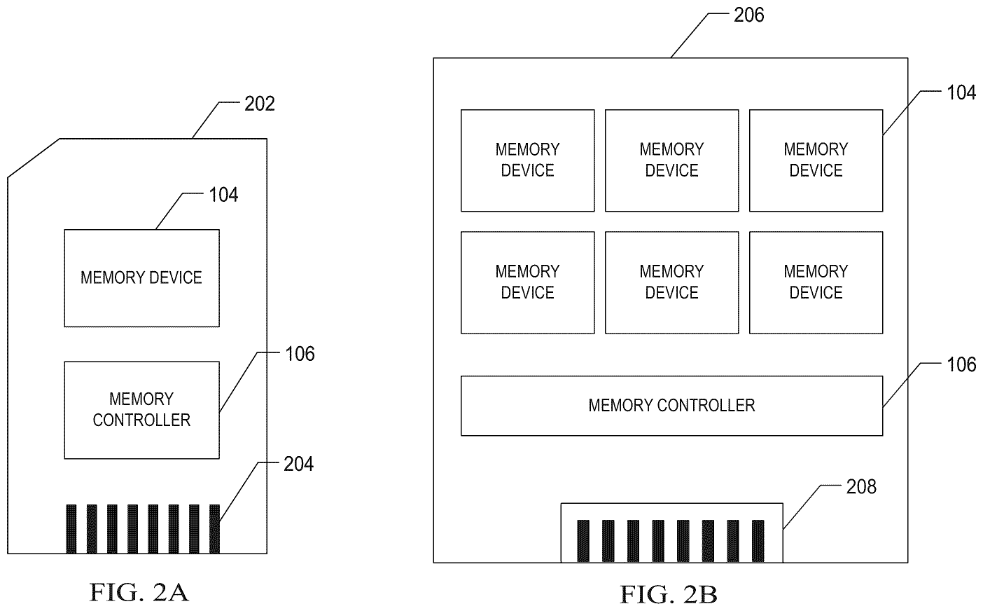

The memory controller 106 and the one or more memory devices 104 can be integrated into various types of storage devices, for example, be included in the same package, such as a universal flash storage (UFS) package or an embedded multi-media card package. That is, the memory system 102 can be implemented and packaged into different types of electronic end products. In one example as shown in FIG. 2A, the memory controller 106 and a single memory device 104 can be integrated into a memory card 202. The memory card 202 may include a compact flash card, a smart-media card, a memory stick, a multi-media card, a secure digital card, a UFS or the like. The memory card 202 may further include a memory card connector 204 coupling the memory card 202 with a host-side device (e.g., the host-side device 108 in FIG. 1). In another example shown in FIG. 2B, the memory controller 106 and a plurality of memory devices 104 may be integrated into an SSD 206. The SSD 206 may also include an SSD connector 208 coupling the SSD 206 and a host-side device (e.g., the host-side device 108 in FIG. 1). In some examples, the memory capacity and/or operating speed of SSD 206 are greater than the memory capacity and/or operating speed of the memory card 202.

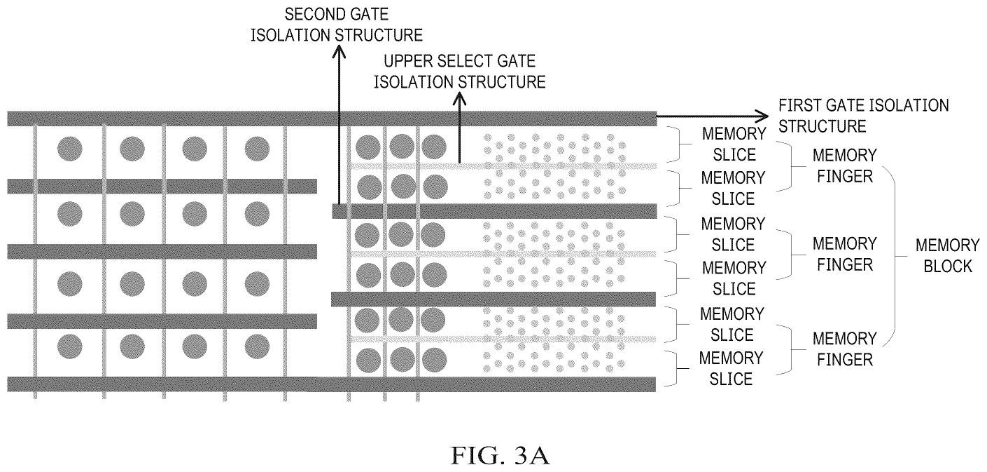

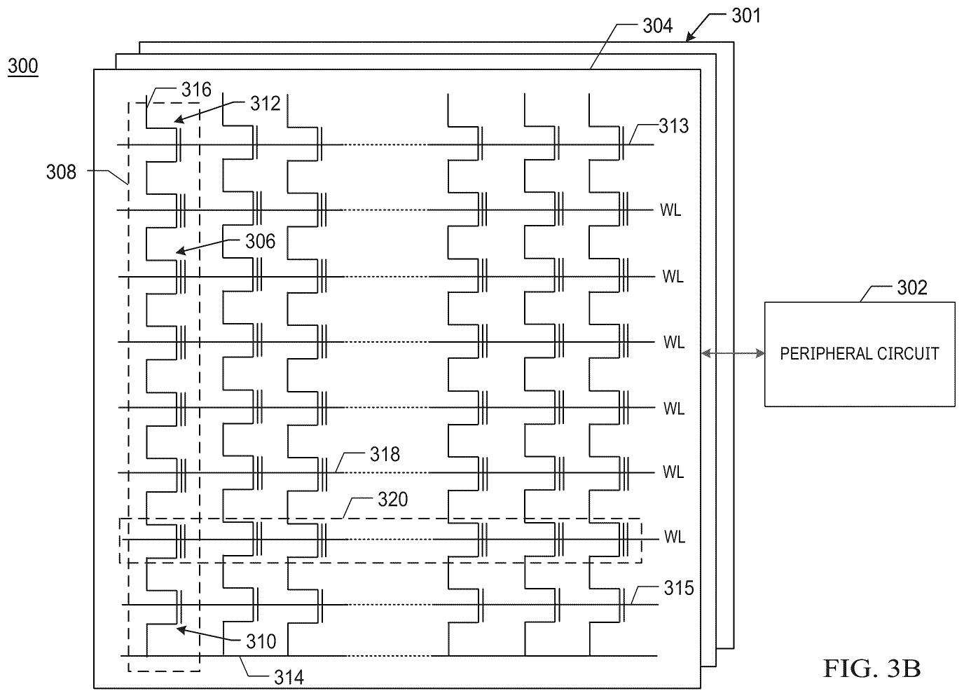

FIG. 3A illustrates a structural diagram of a memory array of a 3D NAND memory. As shown in FIG. 3A, the memory array of the 3D NAND memory is composed of a number of rows of memory cells that are parallel and staggered with respect to each other and parallel to the gate isolation structure. Every four rows of memory cells are isolated by the gate isolation structure and an upper select gate isolation structure. Each row of memory cells includes a plurality of memory cells. The gate isolation structure may include a first gate isolation structure and a second isolation structure. The memory array is divided into a plurality of memory blocks by the first gate isolation structure, and a plurality of second gate isolation structures may divide the memory blocks into a plurality of memory fingers. The memory finger may be divided into two sections by an upper select gate isolation structure disposed in the middle of each memory finger, resulting in two memory slices. FIG. 3A shows that one memory block includes 6 memory slices. However, in practical applications, the number of memory slices in one memory block is not limited to this. Memory cells coupled with a certain word line in one memory slice may be associated with one memory page that is a physical page here.

It is to be noted that the number of rows of memory cells between the gate isolation structure and the upper select gate isolation structure given in FIG. 3A is only an example, and is not intended to limit the number of rows of memory cells included in one memory finger of a 3D NAND memory in the present disclosure. In practical applications, the number of rows of memory cells included in one memory finger can be adjusted according to practical conditions, for example, to be 2, 4, 8, 16 etc.

FIG. 3B shows a schematic circuit diagram of an example memory device 300 including a peripheral circuit in accordance with some aspects of the disclosure. The memory device 300 may be an example of the memory device 104 in FIG. 1. The memory device 300 may include a memory array 301 and a peripheral circuit 302 coupled to the memory array 301. When description is given with a 3D NAND memory array taken as an example of the memory array 301, memory cells 306 are NAND memory cells and provided in the form of an array of memory strings 308, and each memory string 308 extends vertically over a substrate (not shown). In some examples, each memory string 308 includes a plurality of memory cells 306 coupled in series and stacked vertically. Each memory cell 306 can retain continuous analog values, such as voltages or charges, which depends on the number of electrons trapped in the region of the memory cell 306. Each memory cell 306 may be a memory cell of a floating-gate type that includes a floating-gate transistor or a memory cell of a charge trapping type that includes a charge trapping transistor.

In some examples, each memory cell 306 is single-level cell (SLC) that has two possible memory states and thus can store one bit of data. For example, the first memory state “0” may correspond to a first voltage range, and the second memory state “1” may correspond to a second voltage range. In some examples, each memory cell 306 is a multi-level cell (MLC) that is capable of storing more than a single bit of data in more than four memory states. For example, the MLC may store two bits per cell, three bits per cell (also known as a triple-level cell (TLC)), or four bits per cell (also known as a quad-level cell (QLC)). Each MLC may be programmed to assume a range of possible nominal storage values. In an example, if each MLC stores two bits of data, then the MLC may be programmed to assume one of three possible programming levels from an erased state by writing one of three possible nominal storage values to the cell. A fourth nominal storage value may be used for the erased state.

As shown in FIG. 3B, each memory string 308 may include a bottom select transistor (BST) 310 at its source end and a top select transistor (TST) 312 at its drain end. The BST 310 and The TST 312 may be configured to activate a selected memory string 308 during a read or program operation. In some examples, sources of the memory cell strings 308 in the same memory block 304 are coupled together through the same source line (SL) 314 (e.g., a common SL). In other words, in accordance with some example, all the memory strings 308 in the same memory block 304 have an array common source (ACS). In accordance with some examples, the TST 312 of each memory string 308 is coupled to a corresponding bit line (BL) 316 and can read data from or write data to the bit line 316 through an output bus (not shown). In some examples, each memory string 308 is configured to be selected or deselected by applying a select voltage (e.g., higher than the threshold voltage of the transistor having the TST 312) or a deselect voltage (e.g., 0V) to the corresponding TST 312 through one or more top select lines (TSLs) 313 and/or applying a select voltage (e.g., higher than the threshold voltage having the BST 310) or a deselect voltage (e.g., 0V) to the corresponding BST 310 through one or more bottom select lines (BSLs) 315.

As shown in FIG. 3B, the memory strings 308 can be organized into a plurality of memory blocks 304, each of which may have a common source line 314 (e.g., coupled to the ground). In some examples, each memory block 304 is a basic data unit used for an erase operation. That is, all the memory cells 306 in the same memory block 304 is erased simultaneously. In order to erase the memory cells 306 in the selected memory block, the source line 314 coupled to the selected memory block and the unselected memory blocks in the same plane as the selected memory block may be biased with an erase voltage (Vers), for example, a high positive voltage (e.g., 20V or higher). It is understood that, in some examples, an erase operation may be performed at a half-memory-block level, a quarter-memory-block level, or a level having any suitable number of memory blocks or any suitable fractions of a memory block. Memory cells 306 of adjacent memory strings 308 can be coupled through the word line 318 that selects which row of memory cells 306 is affected by read and program operations. In some examples, each word line 318 is coupled to a page 320 of memory cells 306. The size of one page 320 in bits can relate to the number of memory strings 308 coupled by the word line 318 in one block 304. Each word line 318 can include a plurality of control gates (gate electrodes) at each memory cell 306 in respective page 320 and a gate line coupling the control gates. In connection with FIG. 3A above, one page 320 may include multiple memory cells 306 and a plurality of memory cells are isolated by the upper select gate isolation structure and the gate isolation structure. The plurality of memory cells between the upper select gate isolation structure and the gate isolation structure are arranged in a number of rows of memory cells and each row of memory cells is parallel to the gate isolation structure and the upper select gate isolation structure. The memory cells sharing the same word line in a memory slice form a programmable (read/write) page.

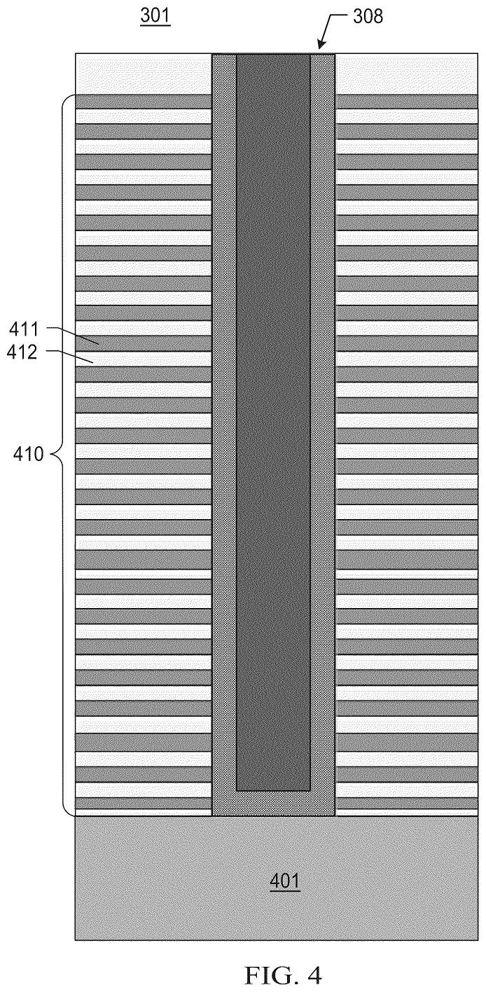

FIG. 4 shows a cross-sectional diagram of an example memory array 301 including a memory string 308 in accordance with some aspects of the present disclosure. As shown in FIG. 4, the memory array 301 may include a stack structure 410 including a plurality of gate layers 411 and a plurality of insulating layers 412 stacked alternately, and the memory string 308 penetrating vertically through the gate layers 411 and the insulating layers 412. The gate layers 411 and the insulating layers 412 may be stacked alternately and two adjacent gate layers 411 are isolated by one insulating layer 412. The number of memory cells included in the memory array 301 is mainly related to the number of pairs of gate layers 411 and insulating layers 412 in the stack structure 410.

The material of the gate layers 411 may include a conductive material. The conductive material includes, but is not limited to, tungsten (W), cobalt (Co), copper (Cu), aluminum (Al), polysilicon, doped silicon, silicide or any combination thereof. In some examples, each gate layer 411 includes a metal layer, for example, a tungsten layer. In some examples, each gate layer 411 includes a doped polysilicon layer. Each gate layer 411 may include a control gate surrounding a memory cell. The gate layer 411 on the top of the stack structure 410 may extend laterally as an upper select gate line and the gate layer 411 at the bottom of the stack structure 410 may extend laterally as a lower select gate line. The gate layers 411 extend laterally between the upper select gate line and the lower select gate line may serve as word line layers.

In some examples, the stack structure 410 may be disposed on a substrate 401. The substrate 401 may include silicon (e.g. single crystal silicon), silicon germanium (SiGe), gallium arsenide (GaAs), germanium (Ge), silicon on insulator (SOI), germanium on insulator (GOI) or any other suitable material.

In some examples, the memory string 308 includes a channel structure extending through the stack structure 410 vertically. In some examples, the channel structure includes a channel hole filled with one or more semiconductor materials (e.g., as a semiconductor channel) and one or more dielectric materials (e.g., as a memory film). In some examples, the semiconductor channel includes silicon, for example, polysilicon. In some examples, the memory film is a composite dielectric layer including a tunneling layer, a storage layer (also referred to as a “charge trapping/storage layer”) and a blocking layer. The channel structure may have a cylindrical shape (e.g., a pillar shape). In accordance with some examples, the semiconductor channel, the tunneling layer, the storage layer and the blocking layer are arranged radially from the center to the outer surface of the pillar in this order. The tunneling layer may include silicon oxide, silicon oxynitride or any combination thereof. The storage layer may include silicon nitride, silicon oxynitride or any combination thereof. The blocking layer may include silicon oxide, silicon oxynitride, a high dielectric constant (high-k) dielectric or any combination thereof. In one example, the memory film may include a composite layer of silicon oxide/silicon oxynitride/silicon oxide (ONO).

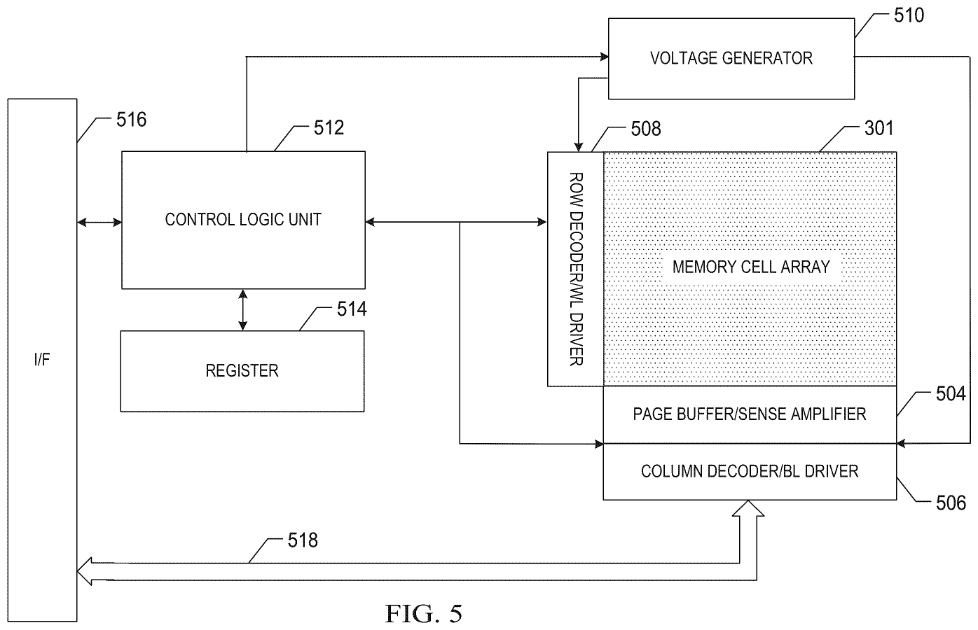

With reference to FIG. 3B again, the peripheral circuit 302 may be coupled to the memory array 301 through the bit line 316, the word line 318, the source line 314, the BSL 315 and the TSL 313. The peripheral circuit 302 may include any suitable analog, digital, and mixed-signal circuits for facilitating operations of the memory array 301 by applying at least one of a voltage signal or a current signal to and sensing at least one of the voltage signal or the current signal from each target memory cell 306 through the bit line 316, the word line 318, the source line 314, the BSL 315 and the TSL 313. The peripheral circuit 302 may include various types of peripheral circuits formed using the metal-oxide-semiconductor technology. For example, FIG. 5 illustrates some example peripheral circuits and the peripheral circuit 302 includes a page buffer/sense amplifier 504, a column decoder/bit line driver 506, a row decoder/word line driver 508, a voltage generator 510, a control logic unit 512, a register 514, an interface 516, and a data bus 518. It should be understood that in some examples, additional peripheral circuits not shown in FIG. 5 may be further included.

The page buffer/sense amplifier 504 can be configured to read and program (write) data from and to the memory array 301 according to the control signal from the control logic unit 512. In one example, the page buffer/sense amplifier 504 may store one page of program data (write data) to be programmed into one page 320 of the memory array 301. In another example, the page buffer/sense amplifier 504 may perform a program verification operation to ensure that the data has been properly programmed into the memory cell 306 coupled to the selected word line 318. In still another example, the page buffer/sense amplifier 504 may also sense a low power signal from the bit line 316 that represent a data bit stored in the memory cell 306, and amplify the small voltage swing to a recognizable logic level in a read operation. The column decoder/bit line driver 506 can be configured to be controlled by the control logic unit 512 and select one or more memory strings 308 by applying a bit line voltage generated from a voltage generator 510.

The row decoder/word line driver 508 can be configured to be controlled by the control logic unit 512 and select/deselect the memory block 304 of the memory array 301 and select/deselect the word line 318 of the memory block 304. The row decoder/word line driver 508 can be further configured to drive the word line 318 using a word line voltage generated from the voltage generator 510. In some examples, the row decoder/word line driver 508 can also select/deselect and drive the BSL 315 and the TSL 313. As described below in detail, the row decoder/word line driver 508 is configured to perform the program operation on the memory cells 306 coupled to one or more selected word lines 318. The voltage generator 510 can be configured to be controlled by the control logic unit 512 and generate a word line voltage (e.g., a read voltage, a program voltage, a pass voltage, a local voltage, a verification voltage, etc.), a bit line voltage, and a source line voltage to be supplied to the memory array 301.

The control logic unit 512 may be coupled to each peripheral circuit described above and configured to control the operation of each peripheral circuit. The register 514 may be coupled to the control logic unit 512 and include a status register, a command register and an address register for storing status information, command operation codes (OP codes) and command addresses for controlling the operation of each peripheral circuit. The interface 516 may be coupled to the control logic unit 512 and serve as a control buffer to buffer the control commands received from the host-side device (not shown) and relay them to the control logic unit 512, and buffer the status information received from the control logic unit 512 and relay them to the host-side device. The interface 516 may be further coupled to the column decoder/bit line driver 506 through the data bus 518, and serve as a data I/O interface and a data buffer to buffer data, and relay it to the memory array 301 or relay or buffer data from the memory array 301.

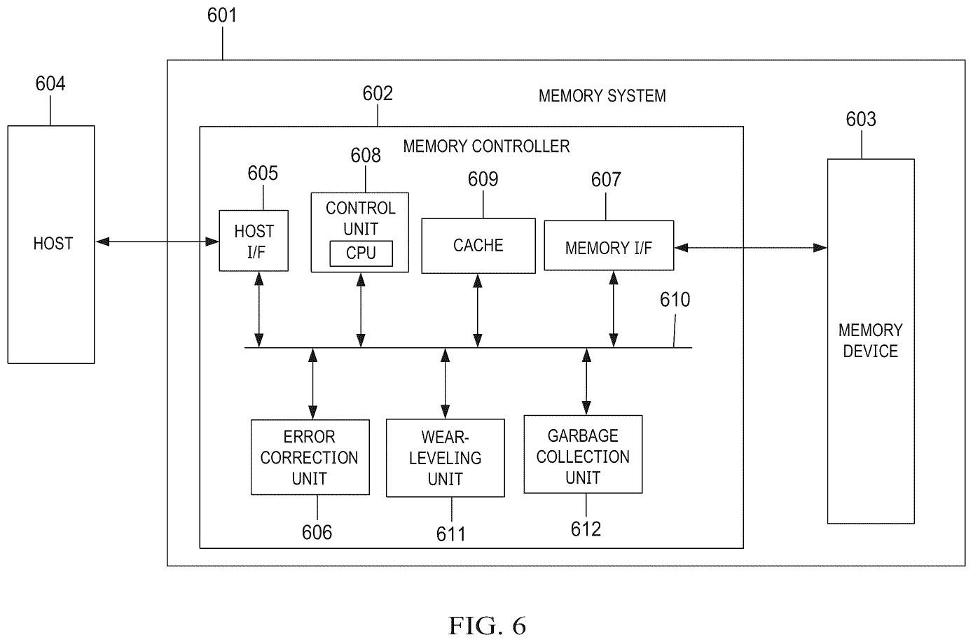

FIG. 6 shows a block diagram of components of a memory system 601 that includes a memory controller 602 and a memory device 603. The memory controller 602 is configured to control read/write operations of the memory device 603. Here, the memory controller 602 and the memory device 603 may be coupled with each other in any suitable way. The memory controller 602 includes a control unit (CPU) 608, a cache 609, an error correction unit 606, a host I/F 605, a memory I/F 607, a wear-leveling unit 611, a garbage collection unit 612. In an example of the present disclosure, the memory device 603 may be a non-volatile semiconductor memory for data storage, for example, an NAND memory. The memory system 601 is connected with the host 604. The host I/F 605 outputs the commands, valid data (write data) and the like received from the host 604 to the internal bus 610, and sends the valid data (read data) read from the memory device 603, the response from the control unit 608 and the like to the host 604.

The memory I/F 607 controls the processing of data writing to and data reading from the memory device 603 based on the instruction from the control unit 608. The control unit 608 controls the memory system 601 globally, and is, for example, a central processor (CPU), a microprocessor (MPU) or the like. When the commands are received from the host 604 through the host I/F 605, the control unit 608 performs control according to the commands. For example, the control unit 608 directs the memory I/F 607 to write data into the memory device 603 according to the commands from the host 604. Furthermore, the control unit 608 directs the memory I/F 607 to read data from the memory device 603 according to the commands from the host 604.

The cache 609 saves temporarily data received from the host 604 before storing it into the memory device 603, and saves temporarily data read from the memory device 603 before sending it to the host 604.

The error correction unit 606 is a data encoding and decoding unit. Since there is a native error rate for storage of a flash memory, for accuracy of data, error checking and correcting (ECC) protection should be applied to the primary data in the write operation of the data, which is an encoding process. When reading data, it also needs to be decoded to detect and correct error, and if the number of error bits exceeds the ECC error correcting capability, the data will be uploaded to the host in an “uncorrectable” form. The process of ECC encoding and decoding here is accomplished by the error correction unit 606.

Read errors may occur because of memory cell aging with increasing of the number of memory cell erase and write operations, electron losing of the memory cell due to long time storage, threshold voltage shift due to a large number of read operations, interference between memory cells, write error and the like, affecting integrity and reliability of the data stored in the storage device.

A flow of reading data includes: firstly, with a first mechanism, reading the data in a target memory page using a default read voltage, and applying a low density parity check (LDPC) hard decoding strategy to data decoding; if reading data using the first mechanism fails, reading the data in the target memory page using a second mechanism that may use a read voltage table managing a plurality sets of read offsets, and if reading data using the default read voltage fails, traversing the read voltage table to change the read voltage and perform read retry (RR); if reading data using the second mechanism still fails, reading the data in the target memory page using a third mechanism that may use a set of offset read voltages to read the data in the target memory page, for example, apply an LDPC soft decoding strategy to data decoding; if reading data using the third mechanism also fails, implementing a fourth mechanism to use a RAID data restoration strategy to handle read errors; and if reading data using the fourth mechanism also fails, reporting data loss of the target memory page to the host.

In some examples, single-level cell soft decoding basically follows the algorithm of multi-level cell soft decoding. However, since a single level cell and a multi-level cell are different in shift magnitude of threshold voltage, if the read retry of the single level cell fails, the voltage shift magnitude will be even larger during the LDPC stage. Moreover, the range of the digital signal processor (DSP) of the multi-level cell is small. As a result, it is not suitable to find the target read voltage using the DSP algorithm of the multi-level cell, making it more difficult to correct back. It is an urgent problem to improve the error correction capability of LDPC decoding.

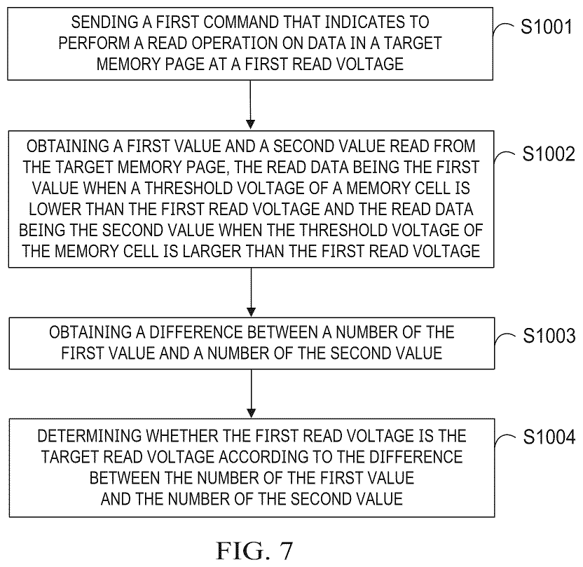

Some examples of the present disclosure provide a method of operating a memory system. As shown in FIG. 7, the method includes the following operations.

In operation S1001, a first command is sent. The first command indicates to perform a read operation on the data in a target memory page at a first read voltage.

In operation S1002, a first value and a second value read from the target memory page are obtained, wherein the read data is the first value when the threshold voltage of a memory cell is lower than the first read voltage and the read data is the second value when the threshold voltage of the memory cell is larger than the first read voltage.

In operation S1003, the difference between the number of the first value and the number of the second value is obtained.

In operation S1004, whether the first read voltage is the target read voltage is determined according to the difference between the number of the first value and the number of the second value.

In some examples, the memory system includes a memory device and a memory controller coupled with the memory device. The memory device includes a plurality of memory pages and the memory cells sharing the same word line in a memory slice in the memory device form a memory page.

In some examples, the execution subject of the examples above may be the memory controller. In some examples, the execution subject of the examples above may be the control unit of the memory controller.

The target read voltage here is also referred to as a trough voltage that represents the read voltage at which the data in the target memory page can be correctly read. The target memory page here can be understood as a memory page, from which data need to be read. Illustratively, a target memory page may store data with the size of 4 KB+512 B, e.g., 4096 B+512 B.

In some examples, each memory page includes a plurality of memory cells, each of which stores one bit of data.

In some examples, the memory cell may be a single-level cell or a multi-level cell used as a single-level cell. That is, each memory cell stores one bit of data. Each memory cell has two possible memory states including a first memory state and a second memory state. The first memory state may be an erased state, and the data corresponding to the first memory state is a first value “0”. The threshold voltage of a memory cell corresponding to the first value may be a first threshold voltage smaller than the trough voltage. The second memory state may be a program state, and the data corresponding to the second memory state is a second value “1”. The threshold voltage of a memory cell corresponding to the second value may be a second threshold voltage larger than the trough voltage.

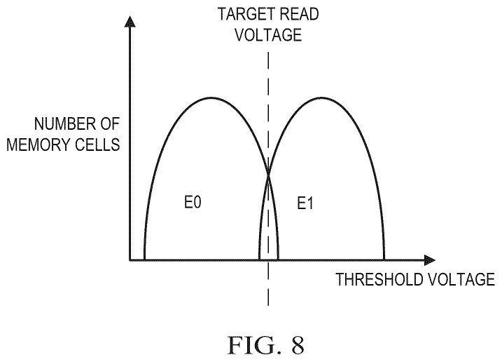

As shown in FIG. 8, which is a schematic diagram of the threshold voltage distribution of a memory cell, the memory cell in the target memory page includes a first memory state E0 and a second memory state E1 with the threshold voltage corresponding to E0 being smaller than that corresponding to E1.

Here, when the threshold voltage of a memory cell is smaller than the first read voltage, the read data is the first value, and when the threshold voltage of the memory cell is larger than the first read voltage, the read data is the second value. It can be understood that, when the threshold voltage of the memory cell is smaller than the first read voltage, the read operation is performed at the first read voltage, and the data read from the memory cell is displayed as 0; and when the threshold voltage of the memory cell is larger than the first read voltage, the read operation is performed at the first read voltage, and the data read from the memory cell is displayed as 1.

It can be understood that when each memory cell stores one bit of data, the number of “0” is close to the number of “1” in the target memory page. When the first read voltage is the trough voltage, all the data are read properly and therefore the number of data “0” read is almost the same as the number of data “1”; and when there is a relatively large difference between the first read voltage and the trough voltage, some of the data may be read improperly, resulting in a relatively large difference between the number of “0” read and the number of “1” read. In examples of the present disclosure, whether the first read voltage is the target read voltage is determined according to the difference between the number of the first value “0” and the number of the second value “1”, so as to find the trough voltage rapidly and efficiently.

In some examples, determining whether the first read voltage is the target read voltage according to the difference between the number of the first value and the number of the second value includes: determining the first read voltage not to be the target read voltage when the absolute value of the difference between the number of the first value and the number of the second value is larger than a preset value; and determining the first read voltage to be the target read voltage when the absolute value of the difference between the number of the first value and the number of the second value is smaller than or equal to the preset value.

It can be understood that, the fact that the absolute value of the difference between the number of the first value and the number of the second value is larger than the preset value indicates a relatively large difference between the first read voltage and the trough voltage, which may cause a relatively high error rate of the read data. As a result, the first reading voltage is not the trough voltage, and it is necessary to change the reading voltage to perform a read operation again. The fact that the absolute value of the difference between the number of the first value and the number of the second value is smaller than or equal to the preset value indicates a relatively small difference between the first read voltage and the trough voltage, which may cause a relatively low error rate of the read data. Therefore, the first read voltage is the trough voltage.

In some examples, the preset value is in the range of 100 to 300.

It is to be noted that the range of the preset value given above is only example and not used to limit the range of the preset value in examples of the present disclosure. In some examples, the preset value may be configured according to the practical acceptable error rate of the read data.

In some examples, the method further includes: sending a second command when the absolute value of the difference between the number of the first value and the number of the second value is larger than a preset value and the number of the first value is larger than the number of the second value, the second command indicating to perform a read operation on the data in the target memory page at a second read voltage, the second read voltage being smaller than the first read voltage; and sending a third command when the absolute value of the difference between the number of the first value and the number of the second value is larger than a preset value and the number of the first value is smaller than the number of the second value, the third command indicating to perform the read operation on the data in the target memory page at a third read voltage, the third read voltage being larger than the first read voltage.

In some examples, at least two circumstances can lead to an absolute value of the difference between the number of the first value and the number of the second value that is larger than the preset value: 1) the first read voltage is smaller than the trough voltage; 2) the first read voltage is larger than the trough voltage. When the first read voltage is at the right side of the trough voltage, that is, the first read voltage is larger than the trough voltage, some of the instances of “1” in the memory cells at the left side of the first read voltage may be read as “0” mistakenly, which makes the number of “0” larger than the number of “1”. Therefore, a voltage lower than the first read voltage needs to be applied to read again. When the first read voltage is at the left side of the trough voltage, that is, the first read voltage is smaller than the trough voltage, some of the instances of “0” in the memory cells at the right side of the first read voltage may be read as “1” mistakenly, which makes the number of “1” larger than the number of “0”. Therefore, a voltage larger than the first read voltage needs to be applied to read again.

In some examples, the obtaining a first value and a second value read from the target memory page and obtaining the difference between the number of the first value and the number of the second value include: storing the first value and the second value read from the target memory page into a register of the memory controller temporarily; and counting the numbers of the first value and the second value using the register.

In some examples, the memory controller includes a register that may be configured to counting the numbers of the first value and the second value read from the target memory page.

In some examples, the memory page corresponds to a read voltage table that includes a plurality of read voltages arranged in order from small to large, the values of two adjacent read voltages differing by a fixed offset; and the method further includes: selecting a read voltage from the read voltage table using a dichotomization method to perform a read operation on the data in the target memory page, when the read operation is performed on the target memory page.

In some examples, the read voltage can be switched continually using a dichotomization method until the numbers of the first value and the second value read are in a balanced state and then the current read voltage can be determined as the target read voltage.

It can be understood that examples of the present disclosure use a dichotomization method to select, from a read voltage table, a read voltage to perform a read operation on the target memory page, so as to improve the read efficiency and reduce the number of read operations.

It is to be noted that the method of selecting a read voltage includes, but is not limited to, the dichotomization method described in the examples above, and may also include a traversing method in some examples.

In some examples, the operation method further includes: receiving the first command sent from the memory controller of the memory system; and sending the first value and the second value read from the target memory page to the memory controller.

In some examples, the memory device includes a peripheral circuit, and the execution subject of receiving the first command and sending the data read from the target memory page to the memory controller in the examples above may be the peripheral circuit.

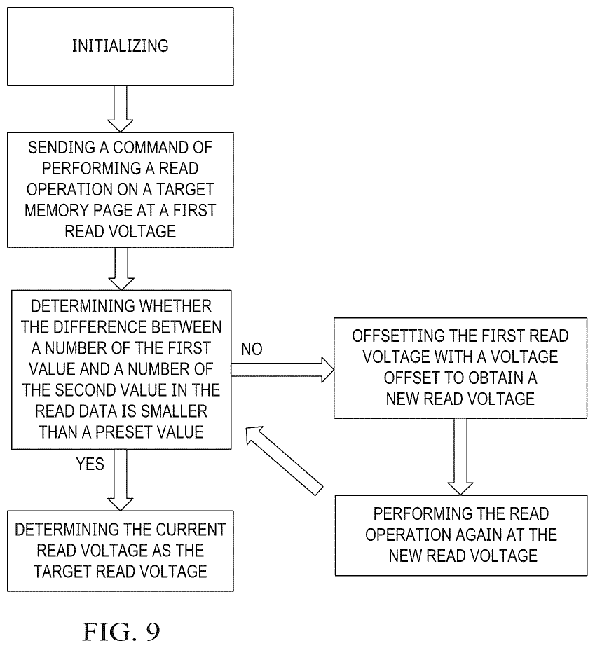

FIG. 9 is a block diagram of an operation method of a memory system provided in the examples of the present disclosure. As shown in FIG. 9, the method includes: initializing; sending a command of performing a read operation on the data in a target memory page at a first read voltage that may be a default read voltage, e.g. a voltage without offset, and setting the size of the data to be read and sent, for example, 4096 B+512 B; subsequently, obtaining the difference between a number of a first value and a number of a second value and determining whether the difference between the number of the first value and the number of the second value is smaller than a preset value; determining the current read voltage as the target read voltage when the difference between the number of the first value and the number of the second value is smaller than the preset value; offsetting the first read voltage with a voltage offset to obtain a new read voltage and perform the read operation again; checking the difference between the number of the first value and the number of the second value of the read data again; determining whether the difference between the number of the first value and the number of the second value is smaller than the preset value again; and if the difference between the number of the first value and the number of the second value is larger than the preset value, changing the read voltage again and performing the read operation until the difference between the number of the first value and the number of the second value is smaller than the preset value.

Examples of the present disclosure provide an operation method of a memory system, which includes: sending a first command that indicates to perform a read operation on the data in a target memory page at a first read voltage; obtaining a first value and a second value read from the target memory page, the read data being the first value when the threshold voltage of a memory cell is lower than the first read voltage and the read data being the second value when the threshold voltage of the memory cell is larger than the first read voltage; obtaining the difference between the number of the first value and the number of the second value; and determining whether the first read voltage is the target read voltage according to the difference between the number of the first value and the number of the second value. In the examples of the present disclosure, by performing a read operation on the target memory page at the first read voltage and then determining whether the first read voltage is the target read voltage according to the difference between the number of the first value and the number of the second value, the position of the target voltage can be determined rapidly, accurately and efficiently, so that the error correction capability of low density parity check codes and the read efficiency can be improved.

Based on the above-described method of operating a memory system, the examples of the present disclosure further provide a computer-readable storage medium having a computer program stored thereon, which, when being executed by a processor, performs the operation method of any one of the examples above.

Here, all or a part of the flow of the method in the examples above can be completed by instructing associated hardware by the computer program that may be stored in a computer readable storage medium and, when being executed, may include the flow of the examples of the above-described methods. The storage medium may be a magnetic disk, an optical disk, a read-only memory (ROM), a random access memory (RAM), a flash memory, a hard disk drive (HDD) or a solid-state, etc. The storage medium may also include a combination of the above kinds of memories.

Based on the above-described operation method of a memory system, the implements of the present disclosure also provide a memory system, which includes a memory device and a memory controller coupled with the memory device. The memory device includes a plurality of memory pages. The memory controller is configured to: send a first command that indicates to perform a read operation on the data in a target memory page at a first read voltage; obtain a first value and a second value read from the target memory page, the read data being the first value when the threshold voltage of the memory cell is lower than the first read voltage, and the read data being the second value when the threshold voltage of the memory cell is larger than the first read voltage; obtain the difference between a number of the first value and a number of the second value; and determine whether the first read voltage is the target read voltage according to the difference between the number of the first value and the number of the second value.

In some examples, the memory controller is configured to: determine the first read voltage not to be the target read voltage when the absolute value of the difference between the number of the first value and the number of the second value is larger than a preset value; and determine the first read voltage to be the target read voltage when the absolute value of the difference between the number of the first value and the number of the second value is smaller than or equal to the preset value.

In some examples, the preset value is in the range of 100 to 300.

In some examples, each of the memory pages includes a plurality of memory cells, each of which stores one bit of data.

In some examples, the memory controller is configured to: send a second command when the absolute value of the difference between the number of the first value and the number of the second value is larger than a preset value and the number of the first value is larger than the number of the second value, the second command indicating to perform a read operation on the data in the target memory page at a second read voltage, the second read voltage being smaller than the first read voltage; and send a third command when the absolute value of the difference between the number of the first value and the number of the second value is larger than the preset value and the number of the first value is smaller than the number of the second value, the third command indicating to perform the read operation on the data in the target memory page at a third read voltage, the third read voltage being larger than the first read voltage.

In some examples, the memory controller includes a register and is configured to: store the first value and the second value read from the target memory page into the register temporarily; and counting the numbers of the first value and the second value using the register.

In some examples, the memory page corresponds to a read voltage table that includes a plurality of read voltages arranged in order from small to large, the values of two adjacent read voltages differing by a fixed offset; and the memory controller is configured to: select a read voltage from the read voltage table using a dichotomization method to perform a read operation on the data in the target memory page, when the read operation is performed on the target memory page.

In some examples, the memory system includes a memory card and a solid-state drive.

In some examples, the memory device includes a memory array and a peripheral circuit coupled with the memory array, and the peripheral circuit is configured to: receive the first command sent from the memory controller; and send the first value and the second value read from the target memory page to the memory controller.

Here, the detailed description with reference to FIGS. 1, 2A, 2B, 3A, 3B, 4, 5 and 6 can be referred to for the structures and components of the memory system, and other details about the memory system are similar to those in the above-described method of operating a memory system and, for brevity, will not repeated here.

Based on the memory system above, the examples of the present disclosure also provide an electronic device including the memory system in any one of the examples above and a host coupled with the memory system.

It can be understood that “one example” or “an example” mentioned throughout the specification means that particular features, structures or characteristics in association with the example may be included in at least one example of the present disclosure. Therefore, “in one example” or “in an example” mentioned throughout the specification refers not necessarily to the same example. Moreover, these particular features, structures or characteristics may be incorporated in one or more examples in any suitable manner. It can be understood that, in various examples of the present disclosure, the ordinal numbers of the various processes above are not intended to indicate that the processes must be performed in any sequential order, and the various processes should be performed in a sequential order determined depending on their functions and inherent logic. Example of examples of the present disclosure is not limited in this respect. The ordinal numbers in the above-mentioned examples of the present disclosure are only for the purpose of description and do not imply the advantages and disadvantages of the examples.

Wherever no collisions will occur, the methods disclosed in the several method examples provided by the present disclosure can be combined arbitrarily to obtain new method examples.

What have been described above are only examples of the present disclosure. However, the scope of the present disclosure is not limited thereto, and variations or substitutions that easily occur to those skilled in the art in light of the technical contents disclosed by the present disclosure will fall within the scope of the present disclosure. Therefore, the scope of the present disclosure should be determined by the scope of the claims.

What is claimed is:

1. A memory system, comprising:
a memory device comprising a plurality of memory pages; and
a memory controller coupled with the memory device and configured to:
send a first command that indicates to perform a read operation on data in a target memory page at a first read voltage;
obtain a first value and a second value read from the target memory page, the read data being the first value responsive to a threshold voltage of a memory cell being lower than the first read voltage, and the read data being the second value responsive to the threshold voltage of the memory cell being larger than the first read voltage;
obtain a difference between a number of the first value and a number of the second value; and
determine whether the first read voltage is a target read voltage according to the difference between the number of the first value and the number of the second value.

2. The memory system of claim 1, wherein the memory controller is configured to:
determine the first read voltage not to be the target read voltage responsive to an absolute value of the difference between the number of the first value and the number of the second value being larger than a preset value; and
determine the first read voltage to be the target read voltage responsive to the absolute value of the difference between the number of the first value and the number of the second value being smaller than or equal to the preset value.

3. The memory system of claim 2, wherein the preset value is in a range of 100 to 300.

4. The memory system of claim 1, wherein each of the memory pages comprises a plurality of memory cells, each of which stores one bit of data.

5. The memory system of claim 1, wherein the memory controller is configured to:
send a second command responsive to an absolute value of the difference between the number of the first value and the number of the second value being larger than a preset value and the number of the first value is larger than the number of the second value, the second command indicating to perform the read operation on the data in the target memory page at a second read voltage, the second read voltage being smaller than the first read voltage; and
send a third command responsive to the absolute value of the difference between the number of the first value and the number of the second value being larger than the preset value and the number of the first value is smaller than the number of the second value, the third command indicating to perform the read operation on the data in the target memory page at a third read voltage, the third read voltage being larger than the first read voltage.

6. The memory system of claim 1, wherein the memory controller comprises a register and is configured to:
store the first value and the second value read from the target memory page into the register temporarily; and
count numbers of the first value and the second value using the register.

7. The memory system of claim 1, wherein the memory page corresponds to a read voltage table that comprises a plurality of read voltages arranged in order from small to large, values of two adjacent read voltages differing by a fixed offset; and
the memory controller is configured to:
select the read voltage from the read voltage table using a dichotomization method to perform the read operation on the data in the target memory page, responsive to the read operation being performed on the target memory page.

8. The memory system of claim 1, wherein the memory system comprises a memory card or a solid-state drive.

9. The memory system of claim 1, wherein the memory device comprises a memory array and a peripheral circuit coupled with the memory array, and the peripheral circuit is configured to:
receive the first command sent from the memory controller; and
send the first value and the second value read from the target memory page to the memory controller.

10. An operation method of a memory system, comprising:
sending a first command that indicates to perform a read operation on data in a target memory page at a first read voltage;
obtaining a first value and a second value read from the target memory page, the read data being the first value responsive to a threshold voltage of a memory cell being lower than the first read voltage, and the read data being the second value responsive to the threshold voltage of the memory cell being larger than the first read voltage;
obtaining a difference between a number of the first value and a number of the second value; and
determining whether the first read voltage is a target read voltage according to the difference between the number of the first value and the number of the second value.

11. The operation method of claim 10, wherein the determining whether the first read voltage is the target read voltage according to the difference between the number of the first value and the number of the second value comprises:
determining the first read voltage not to be the target read voltage responsive to an absolute value of the difference between the number of the first value and the number of the second value being larger than a preset value; and
determining the first read voltage to be the target read voltage responsive to the absolute value of the difference between the number of the first value and the number of the second value being smaller than or equal to the preset value.

12. The operation method of claim 11, wherein the preset value is in a range of 100 to 300.

13. The operation method of claim 10, further comprising:
sending a second command responsive to an absolute value of the difference between the number of the first value and the number of the second value being larger than a preset value and the number of the first value is larger than the number of the second value, the second command indicating to perform the read operation on the data in the target memory page at a second read voltage, the second read voltage being smaller than the first read voltage; and
sending a third command responsive to the absolute value of the difference between the number of the first value and the number of the second value being larger than the preset value and the number of the first value is smaller than the number of the second value, the third command indicating to perform the read operation on the data in the target memory page at a third read voltage, the third read voltage being larger than the first read voltage.

14. The operation method of claim 10, wherein the obtaining the first value and the second value read from the target memory page and obtaining the difference between the number of the first value and the number of the second value comprise:
storing the first value and the second value read from the target memory page into a register of a memory controller temporarily; and
counting the numbers of the first value and the second value using the register.

15. The operation method of claim 10, wherein the memory page corresponds to a read voltage table that comprises a plurality of read voltages arranged in order from small to large, values of two adjacent read voltages differing by a fixed offset; and
the method further comprises:
selecting a read voltage from the read voltage table using a dichotomization method to perform the read operation on the data in the target memory page, responsive to the read operation being performed on the target memory page.

16. The operation method of claim 10, further comprising:
receiving the first command sent from a memory controller of the memory system; and
sending the first value and the second value read from the target memory page to the memory controller.
